(19) United States
(12) Patent Application Publication
(10) Pub. No.: US 2026/0148692 A1
(43) Pub. Date: May 28, 2026

(54) PIXEL CIRCUIT, DISPLAY DEVICE INCLUDING THE PIXEL CIRCUIT, AND ELECTRONIC DEVICE INCLUDING THE DISPLAY DEVICE

(71) Applicant: Samsung Display Co., LTD., Yongin-si (KR)

(72) Inventors: KYUNG-BAE KIM, Yongin-si (KR); DONGWOO KIM, Yongin-si (KR); YEONKYUNG KIM, Yongin-si (KR); YONGHEE LEE, Yongin-si (KR)

(21) Appl. No.: 19/273,777

(22) Filed: Jul. 18, 2025

(30) Foreign Application Priority Data
Nov. 22, 2024 (KR) 10-2024-0168728

(51) Int. Cl. G09G 3/3233; G09G 3/32

(52) U.S. Cl. CPC G09G 3/3233; G09G 3/32; G09G 2300/0819; G09G 2310/08

(57) ABSTRACT

A pixel circuit includes a data write transistor, a driving transistor, a light emitting element, and an initialization transistor. A frame period in which the pixel circuit is operated includes an emission period in which the light emitting element emits a light, and a non-emission period in which the light emitting element does not emit the light. In the emission period, the voltage determined based on the driving current is applied to the anode electrode, and in the non-emission period, the initialization voltage is applied to the anode electrode. The initialization voltage has a first level in an emission period and a second level different from the first level in the non-emission period.

This application claims priority to Korean Patent Application No. 10-2024-0168728, filed on Nov. 22, 2024, and all the benefits accruing therefrom under 35 U.S.C. § 119, the content of which in its entirety is herein incorporated by reference.

### BACKGROUND

### 1. Field

Embodiments of the present invention relates to a pixel circuit, a display device including the pixel circuit, and an electronic device including the display device. More particularly, the present invention relates to a pixel circuit, a display device including the pixel circuit, and an electronic device including the display device for preventing a damage to a transistor.

### 2. Description of the Related Art

In general, a display device includes a display panel and a display panel driver. The display panel includes gate lines, emission lines, data lines, and pixel circuits. The display panel driver includes a gate emission driver for providing a gate signal to the gate lines and an emission signal to the emission lines, a data driver for providing a data voltage to the data lines, and a driving controller for controlling the gate emission driver and the data driver.

Each of the pixel circuits may include a driving transistor, a data write transistor, an initialization transistor, etc. Each of transistors included in the pixel circuits has a withstand voltage. The withstand voltage of the transistor means the maximum voltage which the transistor may withstand. For example, the withstand voltage may be a drain-source voltage of the transistor. When the drain-source voltage of the transistor is greater than the withstand voltage of the transistor, an insulation characteristic of the transistor may be destroyed, such the transistor may be damaged. Accordingly, a display quality of the display device may be degraded.

### SUMMARY

Embodiments of the present invention provide a pixel circuit for preventing a damage to a transistor to improve a display quality.

Embodiments of the present invention provide a display device including the pixel circuit.

Embodiments of the present invention provide an electronic device including the display device.

In an embodiment of a gate driver according to the present invention, the pixel circuit includes a data write transistor configured to output a data voltage in response to a data write gate signal, a driving transistor configured to generate a driving current based on the data voltage, a light emitting element including an anode electrode to which the driving current is applied and configured to emit a light based on a voltage of the anode electrode determined based on the driving current, and an initialization transistor configured to apply an initialization voltage to the anode electrode in response to an initialization gate signal. A frame period in which the pixel circuit is operated includes an emission period in which the light emitting element emits the light, and a non-emission period in which the light emitting element does not emit the light. In the emission period, the voltage determined based on the driving current is applied to the anode electrode, and in the non-emission period, the initialization voltage is applied to the anode electrode. The initialization voltage has a first level in the emission period and a second level different from the first level in the non-emission period.

In an embodiment, the first level may be greater than the second level.

In an embodiment, a difference between the voltage of the anode electrode in the emission period and the first level of the initialization voltage may be less than a difference between the voltage of the anode electrode in the emission period and the second level of the initialization voltage.

In an embodiment, the difference between the voltage of the anode electrode in the emission period and the first level of the initialization voltage may be less than a withstand voltage of the initialization transistor.

In an embodiment, the first level of the initialization voltage may be determined based on a voltage of the anode electrode corresponding to the maximum grayscale of an input image data.

In an embodiment, the driving current generated based on the data voltage may increase when a grayscale of the input image data increases, and the voltage of the anode electrode increases when the driving current increases.

In an embodiment, a difference between the voltage of the anode electrode corresponding to the maximum grayscale and the first level of the initialization voltage may be less than or equal to a withstand voltage of the initialization transistor.

In an embodiment, the light emitting element may include a first light emitting element, which expresses a first color, a second light emitting element, which expresses a second color different from the first color, and a third light emitting element, which expresses a third color different from the first color and the second color. A voltage of the anode electrode of the first light emitting element corresponding to the maximum grayscale for the first color, a voltage of the anode electrode of the first light emitting element corresponding to the maximum grayscale for the second color, and a voltage of the anode electrode of the first light emitting element corresponding to the maximum grayscale for the third color may be different from each other.

In an embodiment, the initialization voltage may be a progressive signal which is sequentially applied to pixel rows.

In an embodiment, the driving transistor may include a gate electrode connected to a first node, a first electrode connected to a second node, and a second electrode connected to a third node. The data write transistor may include a gate electrode to which the data write gate signal is applied, a first electrode connected to a data line transmitting the data voltage, and a second electrode connected to the first node. The initialization transistor may include a gate electrode to which the initialization gate signal is applied, a first electrode to which the initialization voltage is applied, and a second electrode connected to the third node. The light emitting element may include the anode electrode connected to the third node and the cathode electrode.

In an embodiment, the pixel circuit may further include an emission transistor configured to apply a first power supply voltage to the second node in response to an emission signal.

In an embodiment, the emission transistor may include a gate electrode to which the emission signal is applied, a first electrode to which the first power supply voltage is applied, and a second electrode connected to the second node. A second power supply voltage may be applied to the cathode electrode of the light emitting element.

In an embodiment, the pixel circuit may further include a first capacitor including a first electrode connected to the first node and a second electrode connected to the second node, a second capacitor including a first electrode to which a reference voltage is applied and a second electrode connected to the first node, and a third capacitor including a first electrode connected to the first node and a second electrode connected to the third node.

In an embodiment of a display device according to the present invention, the display device includes a display panel including a pixel circuit, and a display panel driver configured to drive the display panel. The pixel circuit includes a data write transistor configured to output a data voltage in response to a data write gate signal, a driving transistor configured to generate a driving current based on the data voltage, a light emitting element including an anode electrode to which the driving current is applied and configured to emit a light based on a voltage of the anode electrode determined based on the driving current, and an initialization transistor configured to apply an initialization voltage to the anode electrode in response to an initialization gate signal. A frame period in which the pixel circuit is operated includes an emission period in which the light emitting element emits the light, and a non-emission period in which the light emitting element does not emit the light. In the emission period, the voltage determined based on the driving current is applied to the anode electrode, and in the non-emission period, the initialization voltage is applied to the anode electrode. The initialization voltage may have a first level in the emission period and a second level different from the first level in the non-emission period.

In an embodiment, the first level may be greater than the second level.

In an embodiment, a difference between the voltage of the anode electrode in the emission period and the first level of the initialization voltage may be less than a difference between the voltage of the anode electrode in the emission period and the second level of the initialization voltage.

In an embodiment, the difference between the voltage of the anode electrode in the emission period and the first level of the initialization voltage may be less than a withstand voltage of the initialization transistor.

In an embodiment, the first level of the initialization voltage may be determined based on a voltage of the anode electrode corresponding to the maximum grayscale of an input image data.

In an embodiment of an electronic device according to the present invention, the electronic device includes a display panel including a pixel circuit, a display panel driver configured to drive the display panel, and a processor configured to control the display panel driver. The pixel circuit includes a data write transistor configured to output a data voltage in response to a data write gate signal, a driving transistor configured to generate a driving current based on the data voltage, a light emitting element including an anode electrode to which the driving current is applied and configured to emit a light based on a voltage of the anode electrode determined based on the driving current, and an initialization transistor configured to apply an initialization voltage to the anode electrode in response to an initialization gate signal. A frame period in which the pixel circuit is operated includes an emission period in which the light emitting element emits the light, and a non-emission period in which the light emitting element does not emit the light. In the emission period, the voltage determined based on the driving current is applied to the anode electrode, and in the non-emission period, the initialization voltage is applied to the anode electrode. The initialization voltage may have a first level in the emission period and a second level different from the first level in the non-emission period.

According to the pixel circuit, the display device, and the electronic device, the initialization voltage may have the first level in the emission period and the second level different from the first level in the non-emission period. Accordingly, a damage to the initialization transistor may be prevented and the display quality may be improved.

### BRIEF DESCRIPTION OF THE DRAWINGS

The above and other features of embodiments of the present invention will become more apparent by describing in detailed embodiments thereof with reference to the accompanying drawings, in which:

FIG. 1 is a block diagram showing a display device according to embodiments of the present invention;

FIG. 2 is a circuit diagram showing an example of a pixel circuit of FIG. 1;

FIG. 3 is a timing diagram showing an example of driving a pixel circuit of FIG. 2;

FIG. 4 is a circuit diagram showing an example of driving a pixel circuit of FIG. 2 in an initialization period of FIG. 3;

FIG. 5 is a circuit diagram showing an example of driving a pixel circuit of FIG. 2 in an emission period of FIG. 3;

FIG. 6 is a graph showing a driving current versus a voltage of an anode electrode according to a color of a light emitting element of FIG. 2;

FIG. 7 is a circuit diagram showing an example of a pixel circuit of FIG. 1;

FIG. 8 is a timing diagram showing an example of driving a pixel circuit of FIG. 7;

FIG. 9 is a circuit diagram showing an example of driving a pixel circuit of FIG. 7 in an initialization data write period of FIG. 8;

FIG. 10 is a circuit diagram showing an example of driving a pixel circuit of FIG. 7 in a compensation period of FIG. 8;

FIG. 11 is a circuit diagram showing an example of driving a pixel circuit of FIG. 7 in an anode holding period of FIG. 8;

FIG. 12 is a circuit diagram showing an example of driving a pixel circuit of FIG. 7 in an emission period of FIG. 8;

FIG. 13 is a block diagram showing an electronic device; and

FIG. 14 is a diagram showing an embodiment in which an electronic device of FIG. 13 is implemented as a VR device.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Hereinafter, the present invention will be described in more detail with reference to the accompanying drawings.

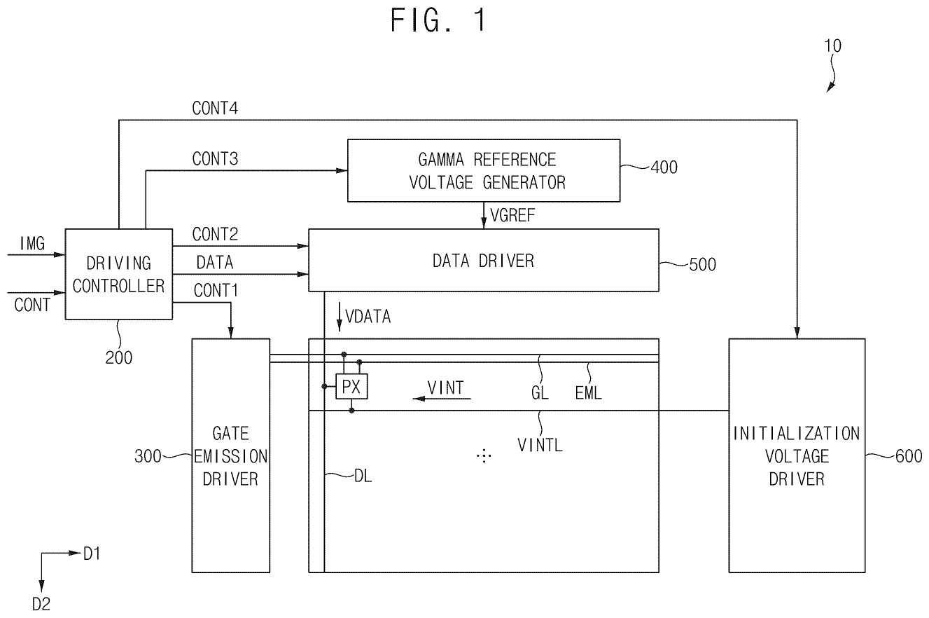

FIG. 1 is a block diagram showing a display device 10 according to embodiments of the present invention.

Referring to FIG. 1, a display device 10 may include a display panel 100 and a display panel driver. The display panel driver may include a driving controller 200, a gate emission driver 300, a gamma reference voltage generator 400, a data driver 500, and an initialization voltage driver 600.

The display panel 100 may include a display area for displaying an image and a peripheral area disposed adjacent to the display area.

For example, in the present embodiment, the display panel 100 may be an organic light emitting diode display panel including an organic light emitting diode. For example, the display panel 100 may be a quantum-dot organic light emitting diode display panel including an organic light emitting diode and a quantum-dot color filter. For example, the display panel 100 may be a quantum-dot nano light emitting diode display panel including a nano light emitting diode and a quantum-dot color filter.

The display panel 100 may include gate lines GL, emission lines EML, data lines DL, initialization lines VINTL, and pixel circuits PX electrically connected to each of the gate lines GL, the emission lines EML, the data lines DL, and the initialization lines VINTL. The gate lines GL, the emission lines EML, and the initialization lines VINTL may extend in a first direction, and the data lines DL may extend in a second direction intersecting the first direction.

The driving controller 200 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate emission driver 300 based on the input control signal CONT, and output the first control signal CONT1 to the gate emission driver 300. The first control signal CONT1 may include a vertical start signal, a gate clock signal, an emission clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the initialization voltage driver 600 based on the input control signal CONT, and output the fourth control signal CONT4 to the initialization voltage driver 600.

The gate emission driver 300 may generate gate signals for driving the gate lines GL and emission signals for driving the emission lines EML in response to the first control signal CONT1 received from the driving controller 200. The gate emission driver 300 may output the gate signals to the gate lines GL and output the emission signals to the emission lines EML. The gate signals and the emission signals may be progressive signals sequentially applied to pixel rows.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

For example, the gamma reference voltage generator 400 may be disposed within the driving controller 200 or may be disposed within the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

The initialization voltage driver 600 may generate initialization voltages VINT for driving the initialization lines VINTL in response to the fourth control signal CONT4 received from the driving controller 200. The initialization voltage driver 600 may output the initialization voltages VINT to the initialization lines VINTL. The initialization voltages VINT may be the progressive signals sequentially applied to the pixel rows.

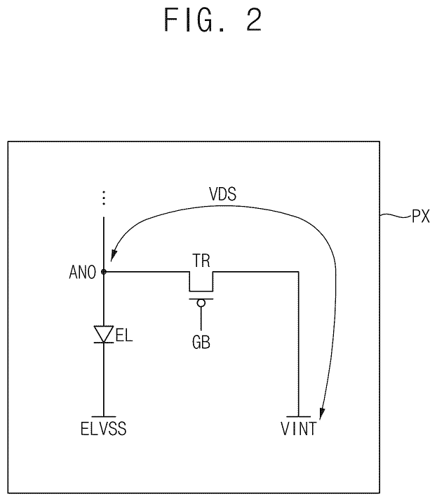

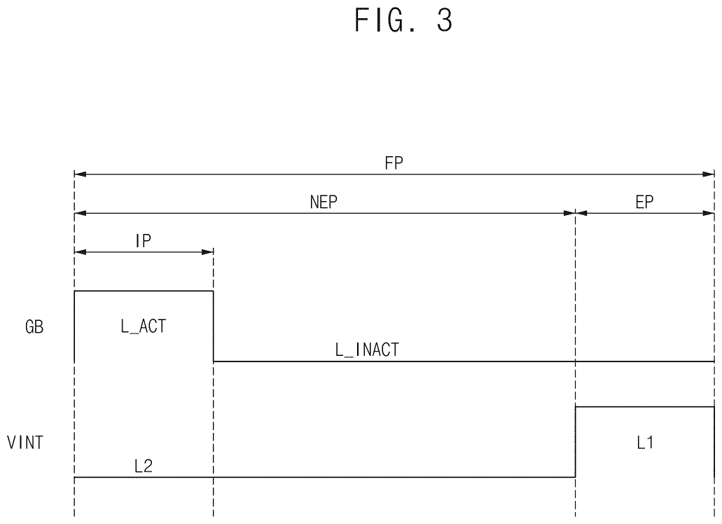

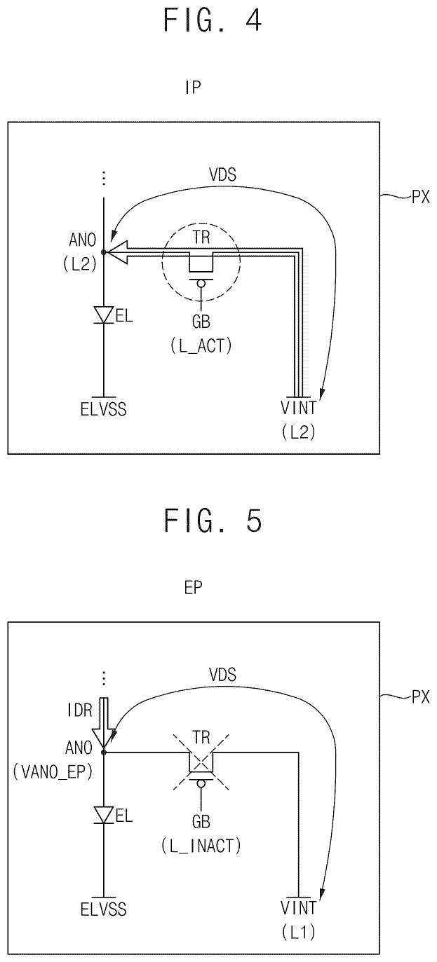

FIG. 2 is a circuit diagram showing an example of a pixel circuit PX of FIG. 1. FIG. 3 is a timing diagram showing an example of driving a pixel circuit PX of FIG. 2. FIG. 4 is a circuit diagram showing an example of driving a pixel circuit PX of FIG. 2 in an initialization period IP of FIG. 3. FIG. 5 is a circuit diagram showing an example of driving a pixel circuit PX of FIG. 2 in an emission period EP of FIG. 3.

Referring to FIGS. 2 and 3, the display panel 100 may include pixel circuits PX. Each of the pixel circuits PX may include a light emitting element EL and an initialization transistor TR. In an embodiment, the initialization transistor TR may be an N-type transistor. However, the present invention is not limited thereto. The initialization transistor TR may be a P-type transistor.

The light emitting element EL may include an anode electrode ANO and a cathode electrode to which a second power supply voltage ELVSS is applied. The initialization transistor TR may include a gate electrode to which an initialization gate signal GB is applied, a first electrode to which an initialization voltage VINT is applied, and a second electrode connected to the anode electrode ANO.

A difference between a voltage of the anode electrode ANO and a level of the initialization voltage VINT may be a drain-source voltage VDS of the initialization transistor TR. When the drain-source voltage VDS of the initialization transistor TR is greater than a withstand voltage of the initialization transistor TR, the initialization transistor TR may be damaged. Therefore, the drain-source voltage VDS of the initialization transistor TR should be less than or equal to the withstand voltage of the initialization transistor TR. For example, the withstand voltage of the initialization transistor TR may be 3.3 V. In this case, the drain-source voltage VDS of the initialization transistor TR should be less than or equal to 3.3 V.

A frame period FP for the pixel circuit PX may include a non-emission period NEP and an emission period EP. The non-emission period NEP may be a period in which the light emitting element EL does not emit a light, and the emission period EP may be a period in which the light emitting element EL emits the light.

The non-emission period NEP may include an initialization period IP. In the initialization period IP, the initialization gate signal GB may have an activation level L_ACT, and the initialization voltage VINT may have a second level L2. The initialization voltage VINT may have the second level L2 not only in the initialization period IP but also the non-emission period NEP. The activation level L_ACT may be a level applied to a gate electrode of a transistor and at which the transistor is turned on. For example, the activation level L_ACT of the initialization gate signal GB may be 5.3 V. For example, the second level L2 may be 1.5 V.

In the emission period EP, the initialization gate signal GB may have a inactivation level L_INACT, and the initialization voltage VINT may have a first level L1. The inactivation level L_INACT may be a level applied to the gate electrode of the transistor and at which the transistor is turned off. The first level L1 may be different from the second level L2. In an embodiment, the first level L1 may be greater than the second level L2. For example, the inactivation level L_INACT of the initialization gate signal GB may be 1.5 V. For example, the first level L1 may be 2.0 V.

Referring to FIGS. 3 and 4, in the initialization period IP, the initialization transistor TR may be turned on in response to the initialization gate signal GB having the activation level L_ACT to apply the initialization voltage VINT having the second level L2 to the anode electrode ANO. Therefore, the voltage of the anode electrode ANO may be the second level L2.

Since the voltage of the anode electrode ANO is the second level L2 and the initialization voltage VINT has the second level L2, the drain-source voltage VDS of the initialization transistor TR may be 0 V. Therefore, since the drain-source voltage VDS of the initialization transistor TR is less than or equal to the withstand voltage (e.g., 3.3 V) of the initialization transistor TR, the initialization transistor TR may not be damaged.

Referring to FIG. 3 and FIG. 5, in the emission period EP, the initialization transistor TR may be turned off in response to the initialization gate signal GB having the inactivation level L_INACT. The initialization voltage VINT may have the first level L1. A driving current IDR may be applied to the anode electrode ANO, and the voltage VANO_EP of the anode electrode ANO may be determined based on the driving current IDR, and the driving current IDR may be determined based on the data voltage VDATA, and the data voltage VDATA may be determined based on a grayscale of input image data IMG.

Therefore, the voltage VANO_EP of the anode electrode ANO may be determined based on the grayscale of the input image data IMG. For example, when the grayscale of the input image data IMG is great, the voltage VANO_EP of the anode electrode ANO may be great. Accordingly, when the grayscale of the input image data IMG is the maximum grayscale, the voltage VANO_EP of the anode electrode ANO may be the maximum voltage, and the drain-source voltage VDS of the initialization transistor TR may be greatest.

In the emission period EP, in order to prevent the damage to the initialization transistor TR, a difference between the maximum voltage of the anode electrode ANO and the first level L1 of the initialization voltage VINT should be less than or equal to the withstand voltage of the initialization transistor TR.

For example, assume that the maximum voltage of the anode electrode ANO is 5.3 V and the initialization voltage VINT has the second level L2 (e.g., 1.5 V). In this case, the drain-source voltage VDS of the initialization transistor TR may be 3.8 V. Since the drain-source voltage VDS of the initialization transistor TR is greater than the withstand voltage of the initialization transistor TR, the initialization transistor TR may be damaged.

In order to prevent the damage to the initialization transistor TR, the initialization voltage VINT may have the first level L1 greater than the second level L2. For example, the maximum voltage of the anode electrode ANO may be 5.3 V and the first level L1 of the initialization voltage VINT may be 2.0 V. Therefore, the drain-source voltage VDS of the initialization transistor TR may be 3.3 V. Since the drain-source voltage VDS of the initialization transistor TR is less than or equal to the withstand voltage of the initialization transistor TR, the initialization transistor TR may not be damaged.

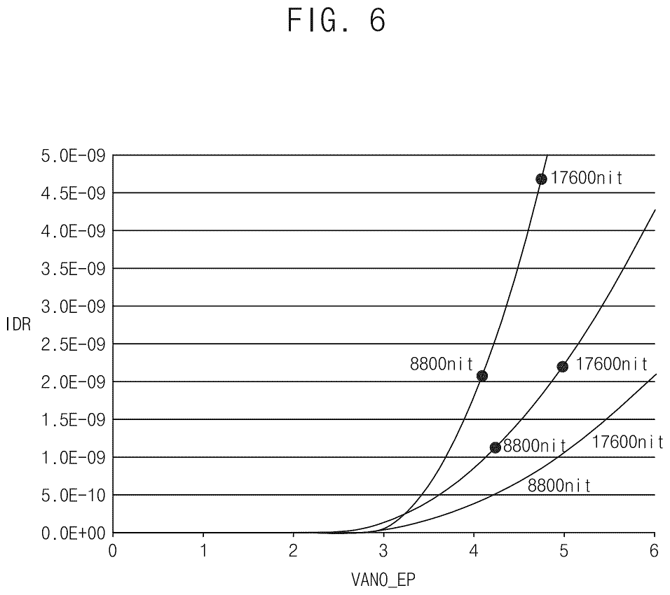

FIG. 6 is a graph showing a driving current IDS versus a voltage VANO_EP of an anode electrode ANO according to a color of a light emitting element EL of FIG. 2.

Referring to FIGS. 1 to 6, the light emitting element EL may include a first light emitting element, which expresses a first color, a second light emitting element, which expresses a second color different from the first color, and a third light emitting element, which expresses a third color different from the first color and the second color. In an embodiment, the first color may be a red, the second color may be a green, and the third color may be a blue. Graphs of FIG. 6 represent a driving current according to a voltage of an anode electrode of the first light emitting element for the first color, a driving current according to a voltage of an anode electrode of the second light emitting element for the second color, and a driving current according to a voltage of an anode electrode of the third light emitting element for the third color.

For example, the maximum luminance of the light emitting element EL may be 17600 nit. In this case, a voltage of an anode electrode corresponding to the maximum grayscale for the first color, a voltage of an anode electrode corresponding to the maximum grayscale for the second color, and a voltage of an anode electrode corresponding to the maximum grayscale for the third color may be different from each other. Therefore, in the emission period EP, the voltage VANO_EP of the anode electrode ANO may be different according to the color expressed by the light emitting element EL.

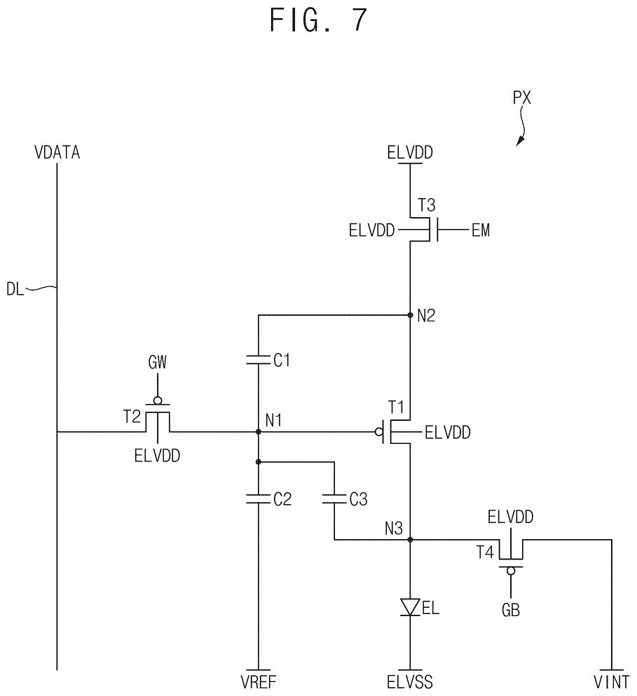

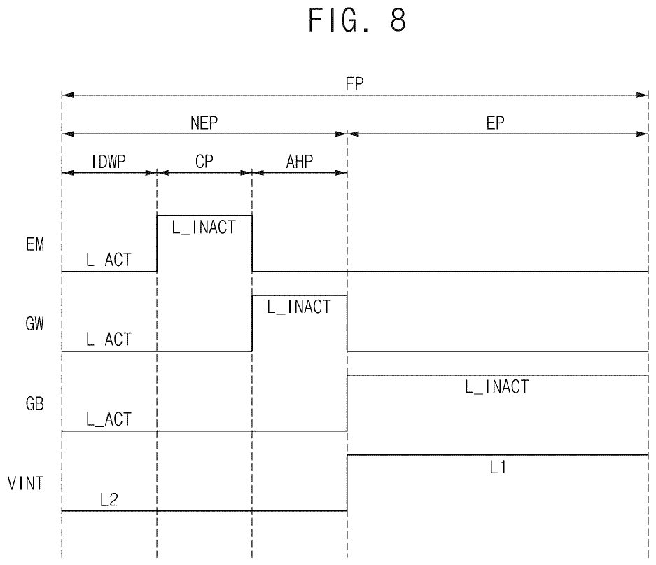

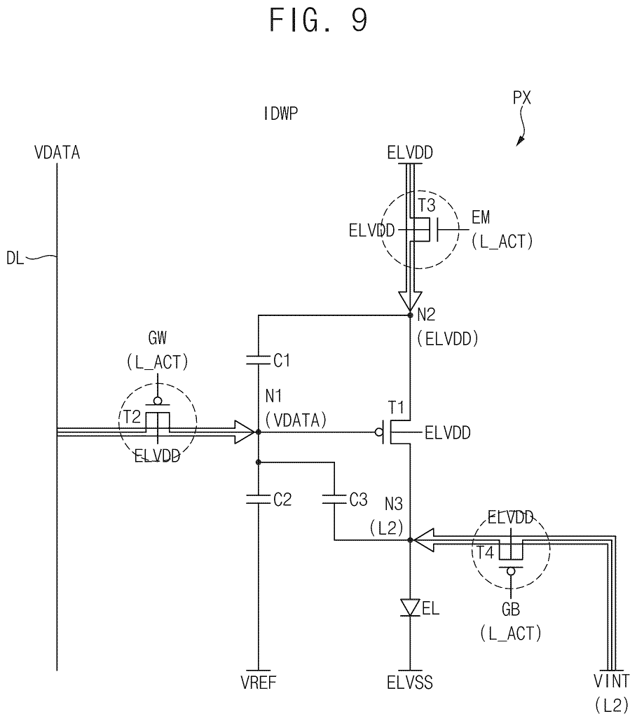

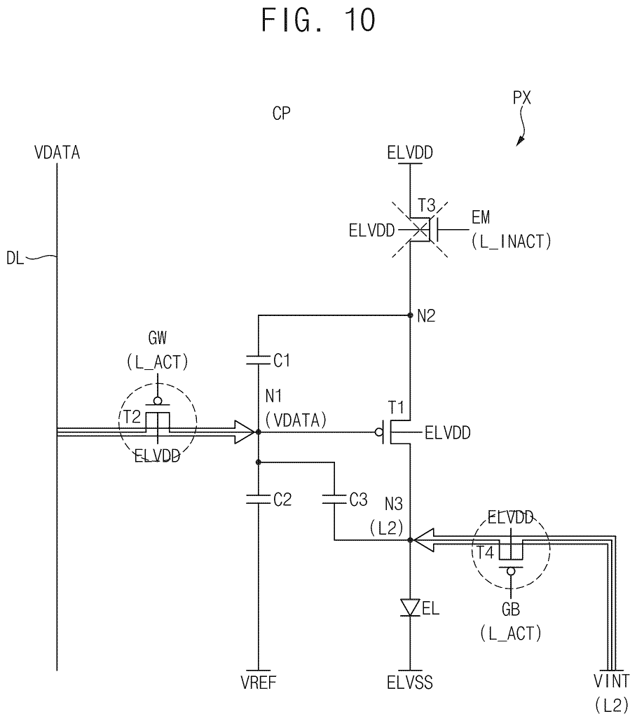

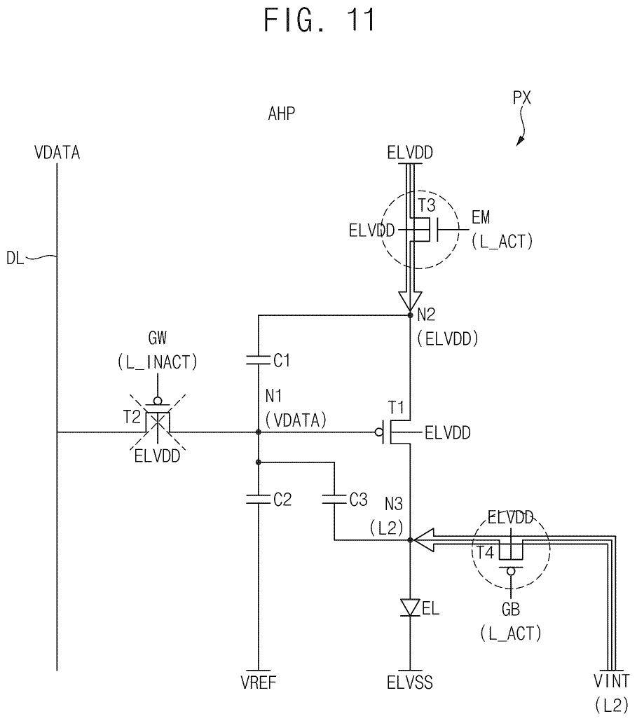

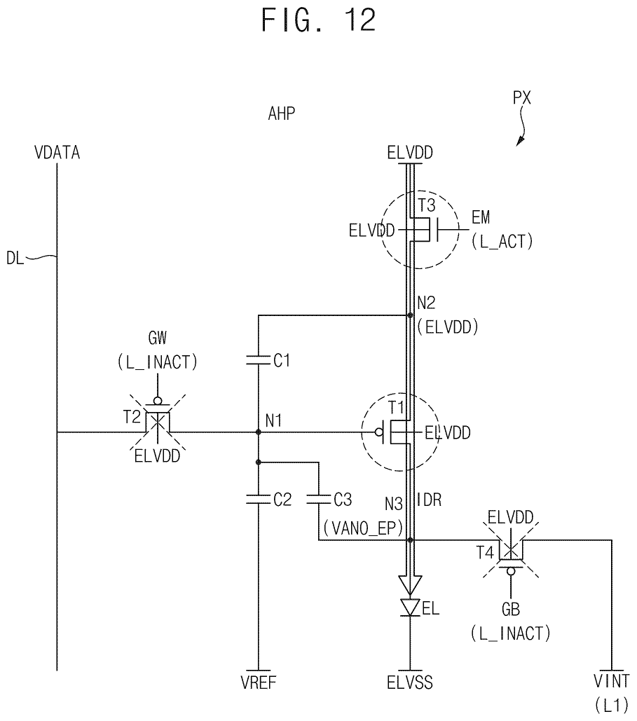

FIG. 7 is a circuit diagram showing an example of a pixel circuit PX of FIG. 1. FIG. 8 is a timing diagram showing an example of driving a pixel circuit PX of FIG. 7. FIG. 9 is a circuit diagram showing an example of driving a pixel circuit PX of FIG. 7 in an initialization data write period IDWP of FIG. 8. FIG. 10 is a circuit diagram showing an example of driving a pixel circuit PX of FIG. 7 in a compensation period CP of FIG. 8. FIG. 11 is a circuit diagram showing an example of driving a pixel circuit PX of FIG. 7 in an anode holding period AHP of FIG. 8. FIG. 12 is a circuit diagram showing an example of driving a pixel circuit PX of FIG. 7 in an emission period EP of FIG. 8.

A pixel circuit of FIG. 2 may be applied to any pixel circuit including an initialization transistor which initializes a voltage of an anode electrode ANO of a light emitting element EL. A pixel circuit of FIG. 7 corresponds to an example to which the pixel circuit of FIG. 2 is applied.

Referring to FIG. 7 and FIG. 8, the display panel 100 may include pixel circuits PX. Each of the pixel circuits PX may include first to fourth transistors T1 to T4, first to third capacitors C1 to C3, and a light emitting element EL. The first to fourth transistors T1 to T4 may be P-type transistors. The fourth transistor T4 of FIG. 7 may correspond to the initialization transistor TR of FIG. 2.

The first transistor T1 may include a gate electrode connected to a first node N1, a first electrode connected to a second node N2, and a second electrode connected to a third node N3. In an embodiment, the first transistor T1 may further include a back gate electrode to which a first power supply voltage ELVDD is applied. The first transistor T1 may generate and output a driving current. The first transistor T1 may be referred to as a “driving transistor”.

The second transistor T2 may include a gate electrode to which a data write gate signal GW is applied, a first electrode connected to a data line DL transmitting a data voltage VDATA, and a second electrode connected to the first node N1. The second transistor T2 may further include a back gate electrode to which the first power supply voltage ELVDD is applied. The second transistor T2 may apply the data voltage VDATA to the first node N1 in response to the data write gate signal GW. The second transistor T2 may be referred to as a “data write transistor”.

The third transistor T3 may include a gate electrode to which an emission signal EM is applied, a first electrode to which the first power supply voltage ELVDD is applied, and a second electrode connected to the second node N2. The third transistor T3 may further include a back gate electrode to which the first power supply voltage ELVDD is applied. The third transistor T3 may apply the first power supply voltage ELVDD to the second node N2 in response to the emission signal EM. The third transistor T3 may be referred to as an “emission transistor”.

The fourth transistor T4 may include a gate electrode to which an initialization gate signal GB is applied, a first electrode to which an initialization voltage VINT is applied, and a second electrode connected to the third node N3. The fourth transistor T4 may further include a back gate electrode to which the first power supply voltage ELVDD is applied. The fourth transistor T4 may apply the initialization voltage VINT to the third node N3 in response to the initialization gate signal GB. The fourth transistor T4 may be referred to as an “initialization transistor”.

The first capacitor C1 may include a first electrode connected to the first node N1 and a second electrode connected to the second node N2.

The second capacitor C2 may include a first electrode receiving a reference voltage VREF and a second electrode connected to the first node N1.

The third capacitor C3 may include a first electrode connected to the second node N2 and a second electrode connected to the third node N3.

The light emitting element EL may include an anode electrode connected to the third node N3 and a cathode electrode to which a second power supply voltage ELVSS is applied.

A frame period FP for the pixel circuit PX may include a non-emission period NEP and an emission period EP. The non-emission period NEP may be a period in which the light emitting element EL does not emit a light, and the emission period EP may be a period in which the light emitting element EL emits the light.

The non-emission period NEP may include an initialization data write period IDWP, a compensation period CP, and an anode holding period AHP. In the initialization data write period IDWP, the emission signal EM may have an activation level L_ACT, the data write gate signal GW may have the activation level L_ACT, the initialization gate signal GB may have the activation level L_ACT, and the initialization voltage VINT may have a second level L2. In the compensation period CP, the emission signal EM may have an inactivation level L_INACT, the data write gate signal GW may have the activation level L_ACT, the initialization gate signal GB may have the activation level L_ACT, and the initialization voltage VINT may have the second level L2. In the anode holding period AHP, the emission signal EM may have the activation level L_ACT, the data write gate signal GW may have the inactivation level L_INACT, the initialization gate signal GB may have the activation level L_ACT, and the initialization voltage VINT may have the second level L2.

In the emission period EP, the emission signal EM may have the activation level L_ACT, the data write gate signal GW may have the activation level L_ACT, the initialization gate signal GB may have the inactivation level L_INACT, and the initialization voltage VINT may have a first level L1.

Referring to FIGS. 8 and 9, in the initialization data write period IDWP, the second transistor T2 may apply the data voltage VDATA to the first node N1 in response to the data write gate signal GW having the activation level L_ACT. Therefore, a voltage of the first node N1 may be the data voltage VDATA.

The third transistor T3 may apply the first power supply voltage ELVDD to the second node N2 in response to the emission signal EM having the activation level L_ACT. Therefore, a voltage of the second node N2 may be initialized to the first power supply voltage ELVDD.

The fourth transistor T4 may apply the initialization voltage VINT having the second level L2 to the third node N3 in response to the initialization gate signal GB having the activation level L_ACT. Therefore, a voltage of the third node N3 may be initialized to the second level L2 of the initialization voltage VINT.

Since the voltage of the third node N3 is the second level L2 and the initialization voltage VINT has the second level L2, a drain-source voltage of the fourth transistor T4 may be 0 V. Therefore, since the drain-source voltage of the fourth transistor T4 is less than or equal to the withstand voltage of the fourth transistor T4, the fourth transistor T4 may not be damaged.

Referring to FIG. 8 and FIG. 10, in the compensation period CP, the second transistor T2 may apply the data voltage VDATA to the first node N1 in response to the data write gate signal GW having the activation level L_ACT. Therefore, the voltage of the first node N1 may be the data voltage VDATA.

The third transistor T3 may be turned off in response to the emission signal EM having the inactivation level L_INACT. Therefore, the first transistor T1 may operate as a source-follower, and the first capacitor C1 may store a component of a threshold voltage of the first transistor T1. Therefore, the threshold voltage of the first transistor T1 may be compensated.

The fourth transistor T4 may apply the initialization voltage VINT having the second level L2 to the third node N3 in response to the initialization gate signal GB having the activation level L_ACT. Therefore, the voltage of the third node N3 may be initialized to the second level L2 of the initialization voltage VINT.

Since the voltage of the third node N3 is the second level L2 and the initialization voltage VINT has the second level L2, the drain-source voltage of the fourth transistor T4 may be 0 V. Therefore, since the drain-source voltage of the fourth transistor T4 is less than or equal to the withstand voltage of the fourth transistor T4, the fourth transistor T4 may not be damaged.

Referring to FIG. 8 and FIG. 11, in the anode holding period AHP, the second transistor T2 may be turned off in response to the data write gate signal GW having the inactivation level L_INACT.

The third transistor T3 may apply the first power supply voltage ELVDD to the second node N2 in response to the emission signal EM having the activation level L_ACT. Therefore, the voltage of the second node N2 may be changed to the first power supply voltage ELVDD. The voltage of the first node N1 may be boosted by the changed voltage of the second node N2 by the first capacitor C1.

The fourth transistor T4 may apply the initialization voltage VINT having the second level L2 to the third node N3 in response to the initialization gate signal GB having the activation level L_ACT. Therefore, the voltage of the third node N3 may be held at the second level L2 of the initialization voltage VINT.

Since the voltage of the third node N3 is the second level L2 and the initialization voltage VINT has the second level L2, the drain-source voltage of the fourth transistor T4 may be 0 V. Therefore, since the drain-source voltage of the fourth transistor T4 is less than or equal to the withstand voltage of the fourth transistor T4, the fourth transistor T4 may not be damaged.

Referring to FIG. 8 and FIG. 12, in the emission period EP, the second transistor T2 may be turned off in response to the data write gate signal GW having the inactivation level L_INACT. The third transistor T3 may be turned on in response to the emission signal EM having the activation level L_ACT. The fourth transistor T4 may be turned off in response to the initialization gate signal GB having the inactivation level L_INACT.

The first transistor T1 may generate and output a driving current IDR. The driving current IDR may be applied to the anode electrode connected to the third node N3. A voltage of the anode electrode may be determined based on the driving current IDR.

As described above, when a grayscale of input image data IMG is the maximum grayscale, the voltage of the anode electrode may be the maximum voltage, and the drain-source voltage of the fourth transistor T4 may be greatest. However, in the emission period EP, since the initialization voltage VINT changes from the second level L2 to the first level L1 greater than the second level L2, the drain-source voltage of the fourth transistor T4 may be less than or equal to the withstand voltage of the fourth transistor T4, and thus the fourth transistor T4 may not be damaged.

As such, the initialization voltage VINT may have the first level L1 in the emission period EP and the second level L2 different from the first level L1 in the non-emission period NEP. Accordingly, the damage to the initialization transistor T4 may be prevented and a display quality may be improved.

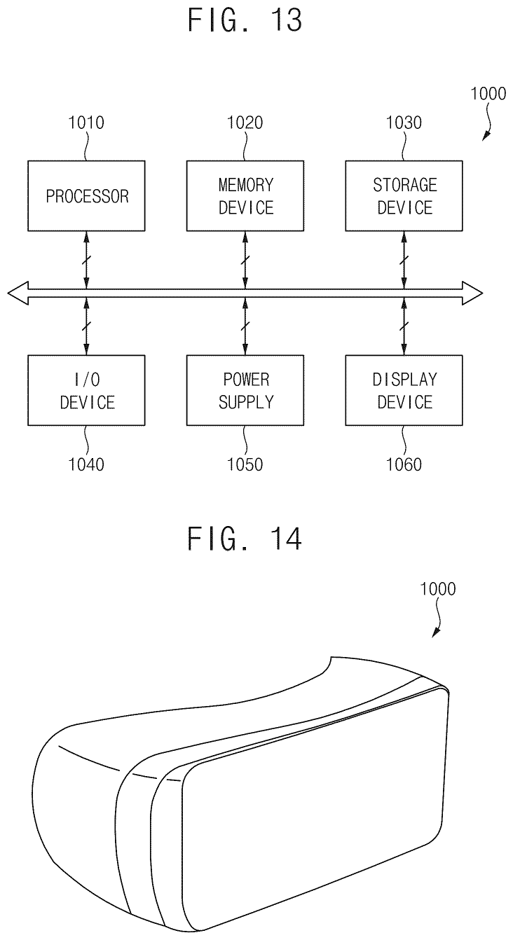

FIG. 13 is a block diagram showing an electronic device 1000. FIG. 14 is a diagram showing an embodiment in which an electronic device 1000 of FIG. 13 is implemented as a virtual reality (VR) device.

Referring to FIGS. 13 and 14, an electronic device 1000 may include a processor 1010, a memory device 1020, a storage device 1030, an input/output I/O device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus USB device, other electronic device, and the like.

In an embodiment, as shown in FIG. 14, the electronic device 1000 may be implemented as a VR device. However, the electronic device 1000 is not limited thereto. For example, the electronic device 1000 may be implemented as a cellular phone, a video phone, a smart pad, a smart phone, a tablet PC, a car navigation system, a computer monitor, a laptop, a head mounted display (HMD) device, and the like.

The processor 1010 may perform various computing functions. The processor 1010 may be a microprocessor, a central processing unit CPU, an application processor AP, and the like. The processor 1010 may be coupled to other components via an address bus, a control bus, a data bus, and the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

The inventions may be applied to any display device and any electronic device including the touch panel. For example, the inventions may be applied to a mobile phone, a smart phone, a tablet computer, a digital television TV, a 3D TV, a personal computer (PC), a home appliance, a laptop computer, a personal digital assistant (PDA), a portable multimedia player (PMP), a digital camera, a music player, a portable game console, a navigation device, etc.

The foregoing is illustrative of the invention and is not to be construed as limiting thereof. Although a few embodiments of the invention have been described, those skilled in the art will readily appreciate that many modifications are possible in the embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A pixel circuit comprising:
a data write transistor, which outputs a data voltage in response to a data write gate signal;
a driving transistor, which generates a driving current based on the data voltage;
a light emitting element including an anode electrode to which the driving current is applied and which emits a light based on a voltage of the anode electrode determined based on the driving current; and
an initialization transistor, which applies an initialization voltage to the anode electrode in response to an initialization gate signal,
wherein a frame period in which the pixel circuit is operated includes an emission period in which the light emitting element emits the light, and a non-emission period in which the light emitting element does not emit the light,
wherein in the emission period, the voltage determined based on the driving current is applied to the anode electrode, and in the non-emission period, the initialization voltage is applied to the anode electrode, and
wherein the initialization voltage has a first level in the emission period and a second level different from the first level in the non-emission period.

2. The pixel circuit of claim 1, wherein the first level is greater than the second level.

3. The pixel circuit of claim 2, wherein a difference between the voltage of the anode electrode in the emission period and the first level of the initialization voltage is less than a difference between the voltage of the anode electrode in the emission period and the second level of the initialization voltage.

4. The pixel circuit of claim 3, wherein the difference between the voltage of the anode electrode in the emission period and the first level of the initialization voltage is less than a withstand voltage of the initialization transistor.

5. The pixel circuit of claim 1, wherein the first level of the initialization voltage is determined based on a voltage of the anode electrode corresponding to a maximum grayscale of an input image data.

6. The pixel circuit of claim 5, wherein the driving current generated based on the data voltage increases when a grayscale of the input image data increases, and the voltage of the anode electrode increases when the driving current increases.

7. The pixel circuit of claim 5, wherein a difference between the voltage of the anode electrode corresponding to the maximum grayscale and the first level of the initialization voltage is less than or equal to a withstand voltage of the initialization transistor.

8. The pixel circuit of claim 1, wherein the light emitting element includes a first light emitting element, which expresses a first color, a second light emitting element, which expresses a second color different from the first color, and a third light emitting element, which expresses a third color different from the first color and the second color, and
wherein a voltage of the anode electrode of the first light emitting element corresponding to a maximum grayscale for the first color, a voltage of the anode electrode of the second light emitting element corresponding to a maximum grayscale for the second color, and a voltage of the anode electrode of the third light emitting element corresponding to a maximum grayscale for the third color are different from each other.

9. The pixel circuit of claim 1, wherein the initialization voltage is a progressive signal which is sequentially applied to pixel rows.

10. The pixel circuit of claim 1, wherein the driving transistor includes a gate electrode connected to a first node, a first electrode connected to a second node, and a second electrode connected to a third node,
wherein the data write transistor includes a gate electrode to which the data write gate signal is applied, a first electrode connected to a data line, which transmits the data voltage, and a second electrode connected to the first node,
wherein the initialization transistor includes a gate electrode to which the initialization gate signal is applied, a first electrode to which the initialization voltage is applied, and a second electrode connected to the third node, and
wherein the light emitting element includes the anode electrode, which is connected to the third node, and the cathode electrode.

11. The pixel circuit of claim 10, wherein the pixel circuit further comprises an emission transistor, which applies a first power supply voltage to the second node in response to an emission signal.

12. The pixel circuit of claim 11, wherein the emission transistor includes a gate electrode to which the emission signal is applied, a first electrode to which the first power supply voltage is applied, and a second electrode connected to the second node, and
wherein a second power supply voltage is applied to the cathode electrode of the light emitting element.

13. The pixel circuit of claim 12, wherein the pixel circuit further comprises:
a first capacitor including a first electrode connected to the first node and a second electrode connected to the second node;
a second capacitor including a first electrode to which a reference voltage is applied and a second electrode connected to the first node; and
a third capacitor including a first electrode connected to the first node and a second electrode connected to the third node.

14. A display device comprising:
a display panel including a pixel circuit; and
a display panel driver, which drives the display panel,
wherein the pixel circuit comprises:
a data write transistor, which outputs a data voltage in response to a data write gate signal;
a driving transistor, which generates a driving current based on the data voltage;
a light emitting element including an anode electrode to which the driving current is applied and, which emits a light based on a voltage of the anode electrode determined based on the driving current; and
an initialization transistor, which applies an initialization voltage to the anode electrode in response to an initialization gate signal,
wherein a frame period in which the pixel circuit is operated includes an emission period in which the light emitting element emits the light, and a non-emission period in which the light emitting element does not emit the light,
wherein in the emission period, the voltage determined based on the driving current is applied to the anode electrode, and in the non-emission period, the initialization voltage is applied to the anode electrode, and
wherein the initialization voltage has a first level in the emission period and a second level different from the first level in the non-emission period.

15. The display device of claim 14, wherein the first level is greater than the second level.

16. The display device of claim 15, wherein a difference between the voltage of the anode electrode in the emission period and the first level of the initialization voltage is less than a difference between the voltage of the anode electrode in the emission period and the second level of the initialization voltage.

17. The display device of claim 16, wherein the difference between the voltage of the anode electrode in the emission period and the first level of the initialization voltage is less than a withstand voltage of the initialization transistor.

18. The display device of claim 14, wherein the first level of the initialization voltage is determined based on a voltage of the anode electrode corresponding to a maximum grayscale of an input image data.

19. An electronic device comprising:
a display panel including a pixel circuit;
a display panel driver, which drives the display panel; and
a processor, which controls the display panel driver,
wherein the pixel circuit comprises:
a data write transistor, which outputs a data voltage in response to a data write gate signal;
a driving transistor, which generates a driving current based on the data voltage;
a light emitting element including an anode electrode to which the driving current is applied and, which emits a light based on a voltage of the anode electrode determined based on the driving current; and
an initialization transistor, which applies an initialization voltage to the anode electrode in response to an initialization gate signal,
wherein a frame period in which the pixel circuit is operated includes an emission period in which the light emitting element emits the light, and a non-emission period in which the light emitting element does not emit the light,
wherein in the emission period, the voltage determined based on the driving current is applied to the anode electrode, and in the non-emission period, the initialization voltage is applied to the anode electrode, and
wherein the initialization voltage has a first level in the emission period and a second level different from the first level in the non-emission period.

20. The electronic device of claim 19, wherein the electronic device is a virtual reality (VR) device, a cellular phone, a video phone, a smart pad, a smart phone, a tablet personal computer (PC), a car navigation system, a computer monitor, a laptop, or a head mounted display device.
